(19) United States
(12) Patent Application Publication
(10) Pub. No.: US 2023/0078653 A1
(43) Pub. Date: Mar. 16, 2023

(54) ROUTE PLANNING

(71) Applicant: Tencent Technology (Shenzhen) Company Limited, Shenzhen (CN)

(72) Inventors: Sheng YANG, Shenzhen (CN); Weizheng LI, Shenzhen (CN); Hongchao ZHAO, Shenzhen (CN); Yuting LIU, Shenzhen (CN)

(73) Assignee: Tencent Technology (Shenzhen) Company Limited, Shenzhen (CN)

(21) Appl. No.: 17/989,157

(22) Filed: Nov. 17, 2022

Related U.S. Application Data
(63) Continuation of application No. PCT/CN2022/081417, filed on Mar. 17, 2022.

(30) Foreign Application Priority Data
Apr. 20, 2021 (CN) 202110423878.6

(51) Int. Cl. G01C 21/36

(52) U.S. Cl. CPC G01C 21/3614; G01C 21/3617

(57) ABSTRACT

A method for route planning includes acquiring a route origin and a route destination, and transmitting, to a route planning server, a route planning request that includes the route origin and the route destination, the route planning request is associated with a travel entity with historical travel information available at the route planning server. Further, the method includes receiving at least one planned route. The at least one planned route includes a first planned route with a familiar route portion determined based on a historical travel route of the travel entity, the first planned route includes the route origin, the familiar route portion with an origin skeleton point and a destination skeleton point, and the route destination, a first distance between the route origin and the origin skeleton point, and a second distance between the route destination and the destination skeleton point are within a preset range.

### RELATED APPLICATIONS

The present application is a continuation of International Application No. PCT/CN2022/081417, entitled “ROUTE PLANNING METHOD AND APPARATUS, AND DEVICE, READABLE STORAGE MEDIUM AND PROGRAM PRODUCT” and filed on Mar. 17, 2022, which claims priority to Chinese Patent Application No. 202110423878.6, entitled “ROUTE PLANNING METHOD AND DEVICE, EQUIPMENT AND COMPUTER READABLE STORAGE MEDIUM” filed on Apr. 20, 2021. The entire disclosures of the prior applications are hereby incorporated by reference in their entirety.

### FIELD OF THE TECHNOLOGY

This application relates to the technical field of maps and transportation, including route planning.

### BACKGROUND OF THE DISCLOSURE

Route planning is a function frequently used by a user when traveling. By means of the function, one or several routes can be planned for the user from huge urban road network data to enable the user to reach a destination designated by the user, and the user can reach the destination as long as traveling according to the planned route. Due to different tolerances and preferences of different users for U-turn, steering and other operations, different users may select different actual routes. In the related art, in the case where a route origin and a route destination are the same, routes planned for different users are substantially the same, thereby causing low degree of personalization of the planned routes returned to the users, and low efficiency of recommending the planned routes for the users.

### SUMMARY

Embodiments of this disclosure provide a route planning method, apparatus and device, and a non-transitory computer-readable storage medium, which can improve the degree of personalization of route planning while improving the planning efficiency and recommendation efficiency of planned routes.

Aspects of the disclosure provide a method for route planning, for example, at a terminal device. The method includes detecting one or more operations indicative of inputting a route origin and a route destination in an origin-destination input region of a route planning interface, acquiring the route origin and the route destination in response to the one or more operations, and transmitting, to a route planning server, a route planning request that includes the route origin and the route destination, the route planning request is associated with a travel entity with historical travel information available at the route planning server. Further, the method includes receiving at least one planned route in response to the route planning request. The at least one planned route includes a first planned route with a familiar route portion determined based on a historical travel route of the travel entity, the first planned route includes the route origin, the familiar route portion with an origin skeleton point and a destination skeleton point, and the route destination, a first distance between the route origin and the origin skeleton point of the familiar route portion, and a second distance between the route destination and the destination skeleton point of the familiar route portion are within a preset range.

Aspects of the disclosure provide another method for route planning, for example at a server device. The method includes receiving a route planning request from a terminal device, the route planning request being associated with a travel entity, the route planning request carries a route origin and a route destination. The method includes acquiring at least one familiar route of the travel entity, the at least one familiar route is determined based on historical travel routes of the travel entity, the at least one familiar route is respectively formed by skeleton points including an origin skeleton point, a destination skeleton point skeleton points. The method further includes determining a planned route including at least a first familiar route portion corresponding to a first familiar route in the at least one familiar route of the travel entity based on the at least one familiar route, the route origin and the route destination, the first familiar route includes first skeleton points including a first origin skeleton point and a first destination skeleton point, a first distance between the route origin and the first origin skeleton point is within a first preset range, and a second distance between the route destination and the first destination skeleton point is within a second preset range. The method then includes sending the planned route to the terminal device.

Aspects of the disclosure provide an apparatus including processing circuitry. The processing circuitry detects one or more operations indicative of inputting a route origin and a route destination in an origin-destination input region of a route planning interface. The processing circuitry acquires the route origin and the route destination in response to the one or more operations, transmits, to a route planning server, a route planning request that includes the route origin and the route destination, the route planning request is associated with a travel entity with historical travel information available at the route planning server. The processing circuitry receives at least one planned route in response to the route planning request, the at least one planned route includes a first planned route with a familiar route portion determined based on a historical travel route of the travel entity, the first planned route includes the route origin, the familiar route portion with an origin skeleton point and a destination skeleton point, and the route destination, a first distance between the route origin and the origin skeleton point of the familiar route portion, and a second distance between the route destination and the destination skeleton point of the familiar route portion are within a preset range.

Embodiments of this disclosure provide a computer-readable storage medium (e.g., a non-transitory computer readable storage medium) storing executable route planning instructions for causing a first processor to implement the route planning method provided at a terminal side according to the embodiments of this disclosure; or for causing a second processor to implement the route planning method provided at a server side according to the embodiments of this disclosure.

Embodiments of this disclosure also provide a computer program product including computer programs or instructions which, when executed by a processor, implement the above route planning methods provided by the embodiments of this disclosure.

Embodiments of the present disclosure may include the following beneficial effects: A terminal may acquire, in response to an operation of a target object for an origin-destination input region, a route origin and a route destination designated by the target object from the origin-destination input region, and receive and display a planned route after transmitting a route planning request carrying the route origin and the route destination to a server. The received planned route includes a target familiar route of the target object, and both a distance between the route origin and an origin skeleton point of the target familiar route of the target object and a distance between the route destination and a destination skeleton point of the target familiar route are within a preset range. Thus, a search space of the planned route can be greatly reduced, the route planning efficiency can be improved, the route recall capability can be enhanced, and the route diversity can be increased in consideration of the route origin, the route destination and the familiar route of the target object. Meanwhile, the target familiar route of the target object can be generalized. When the planned route including the target familiar route is recommended or fed back to the target object, the recommendation efficiency of the recommended planned route can be improved, the utilization rate of familiar routes can be improved, and familiar routes can be returned as far as possible for different objects, and the degree of personalization of route planning can be thus improved.

### BRIEF DESCRIPTION OF THE DRAWINGS

FIG. 1 is an exemplary schematic diagram showing a difference between an actual travel route and a planned route of a user.

FIG. 2 is a schematic architectural diagram of a route planning system 100 according to embodiments of this disclosure.

FIG. 3 is a schematic structural diagram of a terminal according to embodiments of this disclosure.

FIG. 4 is a schematic structural diagram of a server according to embodiments of this disclosure.

FIG. 5 is a first schematic flowchart of a route planning method according to embodiments of this disclosure.

FIG. 6 is a schematic diagram of a route planning interface according to embodiments of this disclosure.

FIG. 7A is a schematic diagram of determining to hit a target familiar route according to embodiments of this disclosure.

FIG. 7B is a schematic diagram of determining to hit a plurality of target familiar routes according to embodiments of this disclosure.

FIG. 8 is a schematic diagram of displaying a planned route according to embodiments of this disclosure.

FIG. 9A is a first schematic diagram of a processed familiar route according to embodiments of this disclosure.

FIG. 9B is a second schematic diagram of a processed familiar route according to embodiments of this disclosure.

FIG. 10A is a first schematic diagram of acquiring a route origin according to embodiments of this disclosure.

FIG. 10B is a second schematic diagram of acquiring a route origin according to embodiments of this disclosure.

FIG. 11A is a first schematic diagram of a route generation identifier according to embodiments of this disclosure.

FIG. 11B is a second schematic diagram of a route generation identifier according to embodiments of this disclosure.

FIG. 12 is a schematic diagram of generating a planned route according to embodiments of this disclosure.

FIG. 13 is a second schematic flowchart of a route planning method according to embodiments of this disclosure.

FIG. 14 is a schematic diagram of extracting dissimilar road links according to embodiments of this disclosure.

FIG. 15 is a schematic diagram of reducing the amount of data through extraction of dissimilar road links according to embodiments of this disclosure.

FIG. 16 is a schematic diagram of skeleton points of a target familiar route according to embodiments of this disclosure.

FIG. 17 is an overall architectural diagram of generating a planned route according to embodiments of this disclosure.

### DESCRIPTION OF EMBODIMENTS

To make the objectives, technical solutions, and advantages of this disclosure clearer, the following describes this disclosure with reference to the accompanying drawings. The described embodiments are not to be considered as a limitation to this disclosure.

In the following descriptions, related “some embodiments” describe a subset of all possible embodiments. However, it may be understood that the “some embodiments” may be the same subset or different subsets of all the possible embodiments, and may be combined with each other without conflict.

In the following descriptions, the included term “first/second/third/fourth” is merely intended to distinguish similar objects but does not necessarily indicate a specific order of an object. It may be understood that “first/second/third/fourth” is interchangeable in terms of a specific order or sequence if permitted, so that the embodiments of this disclosure described herein can be implemented in a sequence in addition to the sequence shown or described herein.

Unless otherwise defined, meanings of all technical and scientific terms used in this specification are the same as those usually understood by a person skilled in the art to which this disclosure belongs. Terms used in this specification are merely intended to describe objectives of the embodiments of this disclosure, but are not intended to limit this disclosure.

Before the embodiments of this disclosure are described in detail, nouns and terms involved in the embodiments of this disclosure are described. The nouns and terms provided in the embodiments of this disclosure are applicable to the following explanations.

(1) Road link, includes for example, a road link in road network data, which is a minimum unit of a road in the road network data. In the road network data, topological structures of roads in a map are composed of road links.

(2) Endpoint, includes for example, an endpoint of a road link.

(3) Road link identifier, includes for example, a unique identifier that distinguishes road links, i.e., each road link has its own identifier.

(4) Dissimilar road link, includes for example, a road link with an origin out-degree being not 1, wherein the origin out-degree refers to the number of paths capable of reaching the road link, and it can be seen therefrom that the dissimilar road link refers to a route reaching the road link being not unique.

(5) Skeleton point, includes for example, a key road link in a route. By means of the skeleton point, a complete route can be restored.

Route planning is a function frequently used by a user when traveling. By means of the function, one or several routes can be planned for the user from huge urban road network data to enable the user to reach a destination designated by the user, and the user can reach the destination as long as traveling according to the planned route.

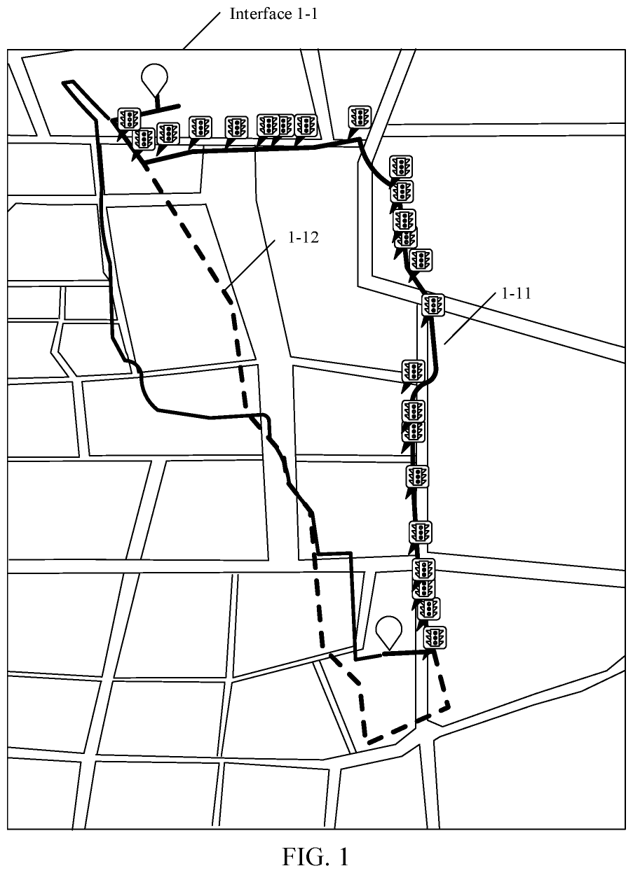

However, due to different tolerances and preferences of different users for U-turn, steering and other operations, different users may select different actual routes. For example, some users tend to travel along routes with less traffic lights, and some users tend to travel along routes with shorter total mileage. While planned routes are substantially the same for different users, it is likely that the user's expectations will not be met. Thus, it may occur that users do not travel along the planned routes, i.e. actual travel routes of the users are different from the planned routes. FIG. 1 is a schematic diagram showing a difference between an actual travel route and a planned route of a user. It can be seen from interface 1-1 in FIG. 1 that a planned route is 1-11, but an actual travel route of a user known according to a positioning technology is 1-12, and the two routes are different.

For this case, in the related art, a route origin and a route destination designated by a user are generally matched with an origin and destination of a route along which the user has traveled, respectively, and when matching is successful, the route along which the user has traveled is recalled and sorted.

However, this manner has a strict matching condition. It is difficult to hit a route along which a user has traveled during route planning, and the route along which the user has traveled is generally a route with which the user is relatively familiar. Thus, it is difficult to return the route with which the user is familiar to the user according to this manner. That is to say, in the related art, there is a lack of a generalization ability for a familiar route, i.e. the possibility of returning the familiar route to a user during route planning is low, so that the familiar route of the user is less utilized during route planning, i.e. planned routes are substantially the same for different users, thereby causing low degree of personalization of the planned routes returned to the users.

In addition, when matching in the above manner, the route along which the user has traveled is required to be completely saved. For example, respective road link identifiers in a complete route are saved using a prefix dictionary tree. However, the amount of data for the complete route is large, making it more stressful to store the route.

Embodiments of this disclosure provide a route planning method, apparatus and device, and a computer-readable storage medium, which can improve the degree of personalization of route planning. Exemplary applications of the route planning device according to embodiments of this disclosure are described below. The route planning device according to the embodiments of this disclosure may be implemented as various types of terminals such as notebook computers, tablet computers, desktop computers, set-top boxes, in-vehicle devices, mobile devices (e.g., mobile phones, portable music players, personal digital assistants, dedicated messaging devices, or portable game devices), also implemented as servers, and further implemented as a device cluster composed of terminals and servers. An exemplary application when the route planning device is implemented as a device cluster composed of terminals and servers will be described below.

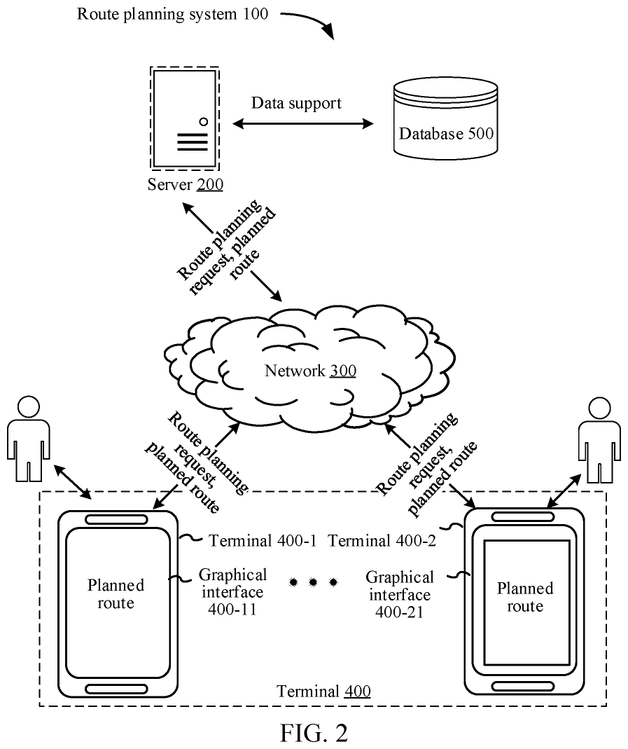

Reference is made to FIG. 2. FIG. 2 is a schematic architectural diagram of a route planning system 100 according to embodiments of this disclosure. In order to support a route planning application, a terminal 400 (a terminal 400-1 and a terminal 400-2 are shown) is connected to a server 200 via a network 300. The network 300 may be a wide area network or a local area network, or a combination of both. The server 200 is also configured with a database 500 for data support to the server 200.

The terminal 400-1 and the terminal 400-2 are configured to receive an origin-destination determining operation for determining a route origin and a route destination in an origin-destination input region of a route planning interface displayed by a graphical interface (a graphical interface 400-11 and a graphical interface 400-21 are shown); acquire a route origin and a route destination in response to the origin-destination determining operation, and transmit a route planning request carrying the route origin and the route destination to the server 200; receive at least one planned route fed back by the server 200 for the route planning request, the at least one planned route including: a target familiar route determined based on a historical travel route of a target object, the planned route being determined according to respective skeleton points of at least one target familiar route, the route origin and the route destination, and both a distance between the route origin and an origin skeleton point of at least one target familiar route and a distance between the route destination and a destination skeleton point of at least one target familiar route being within a preset range; and display the planned route in a route display region of the route planning interface.

In some embodiments, the server 200 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be a smartphone, a tablet computer, an in-vehicle device, a notebook computer, a desktop computer, a smart speaker, a smartwatch, or the like, but is not limited thereto. The terminal and the server may be directly or indirectly connected in a wired or wireless communication manner. This is not limited in the embodiments of this disclosure.

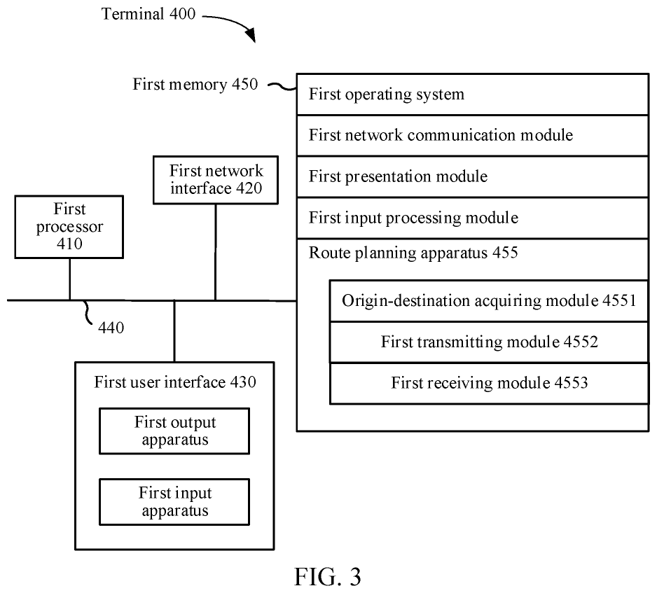

Referring to FIG. 3, FIG. 3 is a schematic structural diagram of a terminal according to embodiments of this disclosure. As shown in FIG. 3, the terminal 400 includes: at least one first processor 410, a first memory 450, at least one first network interface 420, and a first user interface 430. All the components in the terminal 400 are coupled together by a first bus system 440. It may be understood that the first bus system 440 is configured to implement connection and communication between these assemblies. In addition to a data bus, the first bus system 440 further includes a power bus, a control bus, and a state signal bus. However, for clear description, various types of buses in FIG. 3 are marked as the first bus system 440.

In some embodiments, a route planning apparatus 455 according to the embodiments of this disclosure may be implemented in the form of software. FIG. 3 shows a route planning apparatus 455 stored in a first memory 450, which may be software in the form of a program and a plug-in, etc., and includes the following software modules: an origin-destination acquiring module 4551, a first transmitting module 4552 and a first receiving module 4553. These modules are logical, and therefore may be combined or split in various manners according to the functions realized.

The following describes functions of the modules.

In some other embodiments, the route planning apparatus 455 provided in this embodiment of the disclosure may be implemented by using hardware. For example, the route planning apparatus 455 provided in this embodiment of the disclosure may include processing circuitry, such as a processor, in a form of a hardware decoding processor, programmed to perform the route planning method provided in the embodiments of the disclosure. For example, the processor in the form of a hardware decoding processor may use one or more application-specific integrated circuits (ASIC), a DSP, a programmable logic device (PLD), a complex programmable logic device (CPLD), a field-programmable gate array (FPGA), or other electronic components.

Embodiments of this disclosure provide a terminal, including a first memory and a first processor.

The first memory is configured to store executable route planning instructions.

The first processor is configured to implement the route planning method provided at a terminal side according to the embodiments of this disclosure when executing the executable route planning instructions stored in the first memory.

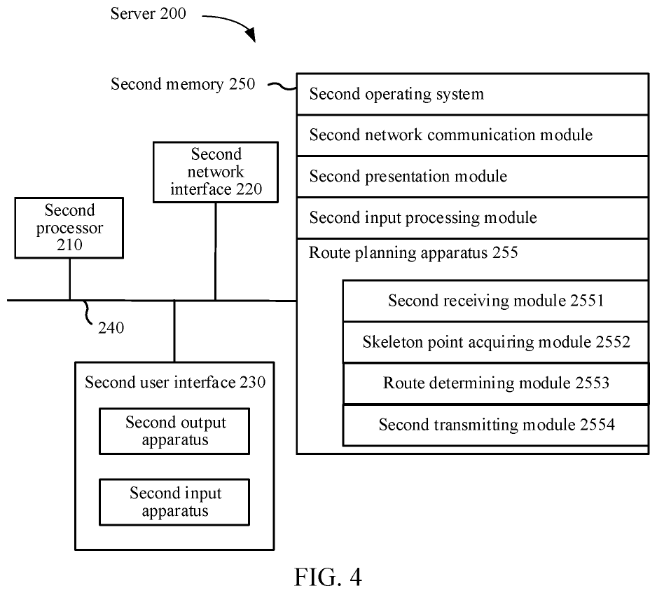

Reference is made to FIG. 4. FIG. 4 is a schematic structural diagram of a server according to embodiments of this disclosure. A server 200 shown in FIG. 4 includes: at least one second processor 210, a second memory 250, at least one second network interface 220, and a second user interface 230. Components in the server 200 are coupled together by using a second bus system 240. It may be understood that the second bus system 240 is configured to implement connection and communication between these assemblies. In addition to a data bus, the second bus system 240 further includes a power bus, a control bus, and a state signal bus. However, for ease of clear description, all types of buses in FIG. 4 are marked as the second bus system 240.

In some embodiments, a route planning apparatus 255 according to the embodiments of this disclosure may be implemented in the form of software. FIG. 4 shows a route planning apparatus 255 stored in a second memory 250, which may be software in the form of a program and a plug-in, etc., and includes the following software modules: a second receiving module 2551, a skeleton point acquiring module 2552, a route determining module 2553, a second transmitting module 2554, and a skeleton point generating module 2555. These modules are logical, and therefore may be randomly combined or split according to the functions realized.

The following describes functions of the modules.

In some other embodiments, the route planning apparatus 255 provided in this embodiment of the disclosure may be implemented by using hardware. For example, the route planning apparatus 255 provided in this embodiment of the disclosure may be a processor in a form of a hardware decoding processor, programmed to perform the route planning method provided in the embodiments of the disclosure. For example, the processor in the form of a hardware decoding processor may use one or more application-specific integrated circuits (ASIC), a DSP, a programmable logic device (PLD), a complex programmable logic device (CPLD), a field-programmable gate array (FPGA), or other electronic components.

Embodiments of this disclosure provide a server, including a second memory and a second processor.

The second memory is configured to store executable route planning instructions.

The second processor is configured to implement the route planning method provided at a server side according to the embodiments of this disclosure when executing the executable route planning instructions stored in the second memory.

The route planning method according to the embodiments of this disclosure will be described below in combination with exemplary applications and implementations of the route planning device according to the embodiments of this disclosure being implemented as a device cluster composed of a server and a terminal. It is to be noted that the server and the terminal may implement the route planning method according to the embodiments of this disclosure by means of a cloud technology in this case.

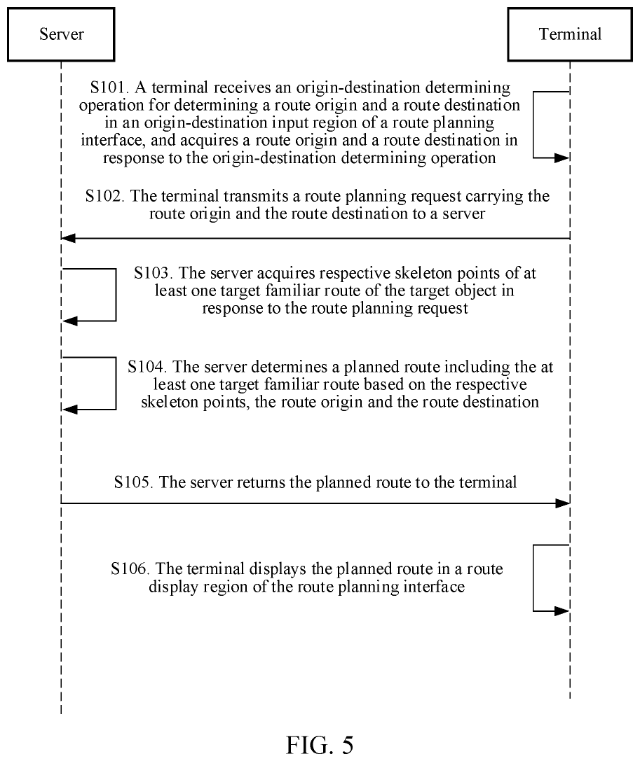

Reference is made to FIG. 5. FIG. 5 is a first schematic flowchart of a route planning method according to embodiments of this disclosure. The description will be made in conjunction with the steps shown in FIG. 5.

In step S101, a terminal receives an origin-destination determining operation for determining a route origin and a route destination in an origin-destination input region of a route planning interface, and acquires a route origin and a route destination in response to the origin-destination determining operation.

The embodiments of this disclosure are realized in a scenario of performing route planning for a target object. For example, a driving route to a certain scenic spot is planned for the target object, or a shopping route is planned for the target object, etc. In a route planning process, a route origin and a route destination are two essential elements. After the terminal displays a route planning interface, a target object operates in an origin-destination input region in the route planning interface to designate a route origin and a route destination. The terminal receives an origin-destination determining operation for determining a route origin and a route destination in the origin-destination input region of the route planning interface, and acquires a route origin and a route destination from the origin-destination input region in response to the origin-destination determining operation.

It is to be understood that the route planning interface is an interface corresponding to a route planning function in a map application, and the target object may jump into the route planning interface after triggering a route planning identifier in a map application interface. The origin-destination input region is a general term of an origin input sub-region for inputting the route origin and a destination input sub-region for inputting the route destination.

In some embodiments, the origin-destination input region may be provided in a first preset region of the route planning interface. Both the size and position of the first preset region may be set according to actual situations. For example, the first preset region is arranged at the top of the route planning interface and has a size of 100×400, or the first preset region is arranged at the right side of the route planning interface and has a size of 400×100, etc. This disclosure is not limited thereto herein.

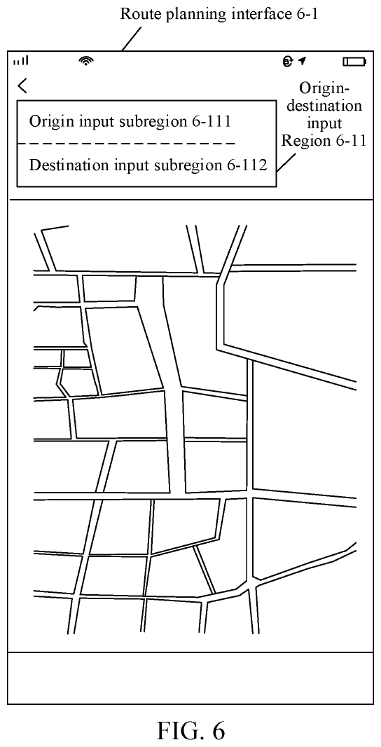

FIG. 6 is a schematic diagram of a route planning interface according to embodiments of this disclosure. Referring to FIG. 6, an origin-destination input region 6-11 is arranged in a route planning interface 6-1. The origin-destination input region 6-11 includes an origin input sub-region 6-111 and a destination input sub-region 6-112, whereby a target object enters a route origin and a route destination, respectively.

Here, the route origin is a departure point of the target object at the time of route planning, and the route destination is a destination point of the target object at the time of route planning. In some embodiments of this disclosure, the route origin may also be a current position of the target object.

In the embodiments of this disclosure, the target object is any user required to perform route planning.

In step S102, the terminal transmits a route planning request carrying the route origin and the route destination to a server.

The terminal generates a route planning request for the target object immediately after obtaining the route origin and the route destination, carries the route origin and the route destination in the route planning request, and then transmits the route planning request to the server via a network. The server receives the route planning request, transmitted by the terminal, carrying the route origin and the route destination designated by the target object.

In step S103, the server acquires respective skeleton points of at least one target familiar route of the target object in response to the route planning request.

The server determines, from its own storage space or from respective routes stored in a database, which routes are familiar to the target object. Since there may be more than one familiar route of the target object, the server can obtain at least one target familiar route. The server may then acquire respective skeleton points of the at least one target familiar route, whereby a planned route is subsequently obtained according to the respective skeleton points of the at least one target familiar route.

It is to be noted that the at least one target familiar route is determined based on a historical travel route of the target object, i.e. the server may acquire a historical travel route of the target object within a historical time period and analyze the historical travel route to determine a preferred route along which a user frequently walks. In some embodiments, for a certain historical travel route of a user, when the number of adoptions (i.e. travels) of the historical travel route by the user reaches a number threshold (which may be set according to actual situations, such as three), it may be determined that the historical travel route is a target familiar route of the target object.

The respective skeleton points of the at least one target familiar route are obtained by thinning the at least one target familiar route, and the at least one target familiar route of the target object can be completely restored through these skeleton points. Thus, the server can restore the at least one target familiar route by only storing information of the skeleton points in the storage space or the database, thereby greatly reducing the storage pressure required for storing the at least one target familiar route.

It is to be understood that each target familiar route has its own corresponding origin skeleton point and destination skeleton point such that at least one origin skeleton point and at least one destination skeleton point are included in the respective skeleton points of the at least one target familiar route. The origin skeleton point may be an origin of the target familiar route, and the destination skeleton point may be a destination of the target familiar route.

In step S104, the server determines a planned route including the at least one target familiar route based on the respective skeleton points, the route origin and the route destination.

It is to be noted that a distance between the route origin and at least one origin skeleton point in the respective skeleton points is within a preset range, and a distance between the route destination and at least one destination skeleton point in the respective skeleton points is within a preset range. That is to say, after obtaining the respective skeleton points of the at least one target familiar route, the server calculates a distance between the route origin and at least one origin skeleton point in the respective skeleton points, determines whether the distance between the route origin and these origin skeleton points is within a preset range, also calculates a distance between the route destination and at least one destination skeleton point in the respective skeleton points, and determines whether the distance between the route destination and these destination skeleton points is within a preset range. When both the distance between the route origin and the at least one origin skeleton point and the distance between the route destination and the at least one destination skeleton point are within the preset range, the server considers that the route origin and the route destination hit at least one target familiar route of the target object. At this moment, the server restores a familiar route according to the respective skeleton points of the at least one target familiar route, and plans a route departing from the route origin to the at least one target familiar route and a route departing from the at least one target familiar route to the route destination on line, thereby splicing a final planned route using the at least one target familiar route, the route from the route origin to the at least one target familiar route and the route from the at least one target familiar route to the route destination.

It is to be noted that the preset range may be set according to actual requirements. For example, the preset range is set as 1 km, or as 2 km, or even as 800 meters, etc. This disclosure is not limited thereto herein.

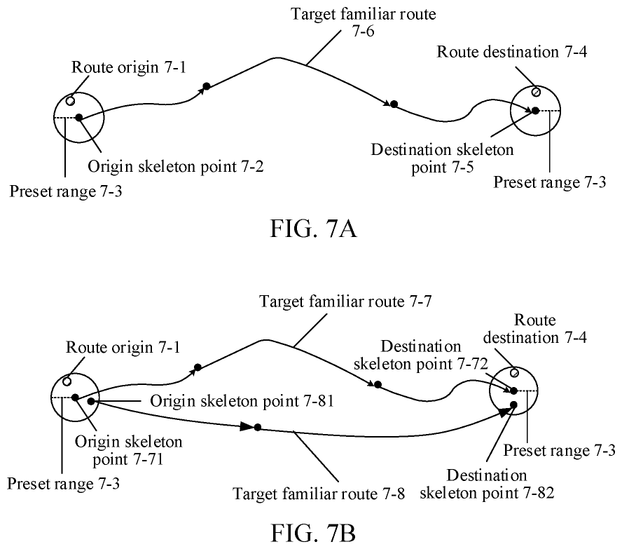

FIG. 7A is a schematic diagram of determining to hit a target familiar route according to embodiments of this disclosure. As shown in FIG. 7A, when the target object has only one target familiar route 7-6, a distance between a route origin 7-1 and an origin skeleton point 7-2 is within a preset range 7-3, and a distance between a route destination 7-4 and a destination skeleton point 7-5 is also within the preset range 7-3, the server will confirm that the route origin 7-1 and the route destination 7-4 hit the target familiar route 7-6.

FIG. 7B is a schematic diagram of determining to hit a plurality of target familiar routes according to embodiments of this disclosure. Referring to FIG. 7B, the target object has a plurality of target familiar routes, which are a target familiar route 7-7 and a target familiar route 7-8, respectively, thus having two origin skeleton points and two destination skeleton points. When the distances from the route origin 7-1 to an origin skeleton point 7-71 of the target familiar route 7-7 and an origin skeleton point 7-81 of the target familiar route 7-8 are both within the preset range 7-3, and the distances from the route destination 7-4 to a destination skeleton point 7-72 of the target familiar route 7-7 and a destination skeleton point 7-82 of the target familiar route 7-8 are both within the preset range 7-3, the server will confirm that the route origin 7-1 and the route destination 7-4 hit the target familiar route 7-7 and the target familiar route 7-8 simultaneously.

In some embodiments, there may be more than one route from the route origin to at least one target familiar route and one route from at least one target familiar route to the route destination planned by the server on line. At this moment, the server may respectively splice these routes with the at least one target familiar route, and use matching degrees between the spliced routes and the at least one target familiar route to select a final planned route.

In other embodiments, there may be only one route from the route origin to at least one target familiar route and one route from at least one target familiar route to the route destination planned by the server on line. At this moment, the server may directly splice these routes to obtain a final planned route.

It is to be understood that in the embodiments of this disclosure, the planned route finally obtained is a general term of the routes returned to the target object, i.e. the planned route may include a plurality of different routes or may have only one route. This disclosure is not limited thereto herein.

In step S105, the server returns the planned route to the terminal.

After obtaining the planned route, the server transmits the planned route to the terminal via the network. The terminal will receive the planned route after transmitting a route planning request to the server. Therefore, the terminal receives a planned route returned by the server for the route planning request and including at least one target familiar route of the target object.

It can be seen from the above content that the planned route is determined according to respective skeleton points of at least one target familiar route, the route origin and the route destination, and a distance between the route origin and an origin skeleton point of at least one target familiar route and a distance between the route destination and a destination skeleton point of at least one target familiar route are within a preset range.

In step S106, the terminal displays the planned route in a route display region of the route planning interface.

In addition to the origin-destination input region, there is a route display region in the route planning interface. After receiving the planned route, the terminal displays the received planned route in the route display region so that the target object may view a route designated thereby from the route origin to the route destination in the route display region.

It is to be understood that the route display region may be arranged in a second preset region of the route planning interface. Similar to the first preset region, the size and position of the second preset region may be set according to actual requirements. This disclosure is not limited thereto herein.

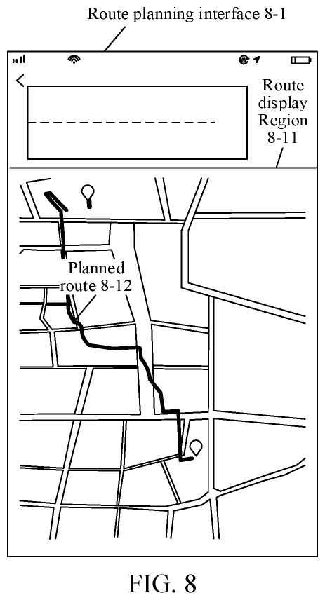

FIG. 8 is a schematic diagram of displaying a planned route according to embodiments of this disclosure. As shown in FIG. 8, a route display region 8-11 is arranged at a lower half part of a route planning interface 8-1, and the terminal displays a received planned route 8-12 in the route display region 8-11, whereby the target object views the planned route 8-12.

In the embodiments of this disclosure, a terminal may acquire, in response to an operation of a target object for an origin-destination input region, a route origin and a route destination designated by the target object from the origin-destination input region, and receive and display a planned route after transmitting a route planning request carrying the route origin and the route destination to a server. The received planned route includes at least one target familiar route of the target object, and both a distance between the route origin and an origin skeleton point of the at least one target familiar route of the target object and a distance between the route destination and a destination skeleton point of the at least one target familiar route are within a preset range. Thus, a search space of the planned route can be greatly reduced, the route planning efficiency can be improved, the route recall capability can be enhanced, and the route diversity can be increased in consideration of the route origin, the route destination and the familiar route of the target object. Meanwhile, the target familiar route of the target object can be generalized. When the planned route including the target familiar route is recommended or fed back to the target object, the recommendation efficiency of the recommended planned route can be improved, the utilization rate of familiar routes can be improved, and familiar routes can be returned as far as possible for different objects, and the degree of personalization of route planning can be thus improved. In addition, since the planned route is determined based on the respective skeleton points of the at least one target familiar route, there is no need to store a complete target familiar route, thereby reducing the storage pressure of the target familiar route.

In some embodiments of this disclosure, in order to make a familiar route more conspicuous and make the target object know that there is a route familiar in a planned route, the implementation process of S106 in which the terminal displays the planned route in a route display region of the route planning interface may include: the following S1061-S1062:

In step S1061, the terminal extracts at least one target familiar route from the planned route.

The terminal may first extract at least one target familiar route from the planned route in order to make the familiar route more conspicuous in the planned route. It is to be noted that in the embodiments of this disclosure, when transmitting a planned route to the terminal, the server may transmit relevant information of at least one target familiar route to the terminal together, and the terminal may determine the at least one target familiar route from the planned route according to the relevant information of the at least one target familiar route, so as to subsequently differentially display the at least one target familiar route and routes other than the target familiar route in the planned route.

It is to be understood that the relevant information of the at least one target familiar route may include: an origin position and a destination position of the at least one target familiar route, which may also include the length of the at least one target familiar route, etc. This disclosure is not limited thereto herein.

In step S1062, the terminal differentially displays, in a route display region of the route planning interface, the at least one target familiar route, and routes other than the target familiar route in the planned route.

After extracting the at least one target familiar route, the terminal may differentially display the at least one target familiar route and other routes, whereby the at least one target familiar route is distinguished from other routes in the planned route. In this way, the target object may be aware of familiar routes in the planned route.

In some embodiments of this disclosure, after S1062, the method may further include: the following S1063 or S1064:

In step S1063, the terminal blinks the at least one target familiar route.

The terminal may distinguish the at least one target familiar route from routes other than the at least one target familiar route in the planned route in a blinking manner by adding a blinking effect to the at least one target familiar route or adding a blinking effect to the periphery of the familiar route.

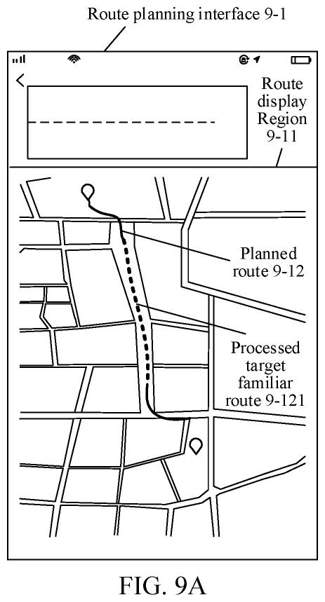

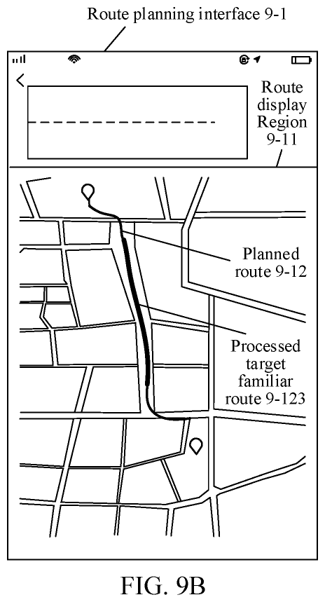

Embodiments of this disclosure provide a first schematic diagram of a processed target familiar route. Referring to FIG. 9A, a planned route 9-12 is displayed in a route display region 9-11 of a route planning interface 9-1. A processed target familiar route 9-121 obtained by blinking can clearly distinguish other routes in the planned route, thereby making the target familiar route more conspicuous.

In step S1064, the terminal highlights the at least one target familiar route.

The terminal may also distinguish the at least one target familiar route from other routes through a highlighting process by adding a highlighting effect to the at least one target familiar route or by adding a highlighting effect to the start and end of the at least one target familiar route.

Embodiments of this disclosure provide a second schematic diagram of a processed target familiar route. Referring to FIG. 9B, a processed target familiar route 9-123 obtained by highlighting can also be distinguished from other routes.

In the embodiments of this disclosure, the terminal may extract at least one target familiar route from the planned route, and highlight or blink the at least one target familiar route so as to make the at least one target familiar route more conspicuous.

In some embodiments of this disclosure, the origin-destination input region includes: an origin input sub-region and a destination input sub-region. The origin-destination determining operation includes: an operation at the origin input sub-region and an operation at the destination input sub-region. In this case, the implementation process of S101 in which the terminal acquires a route origin and a route destination in response to the origin-destination determining operation may include: any or all of the following steps S1011-S1012:

In step S1011, the terminal jumps from the route planning interface to an origin input interface in response to the operation of the target object at the origin input sub-region, and acquires the route origin from the origin input interface in response to the operation of the target object at the origin input interface.

When the target object inputs the route origin, the target object actually operates at an origin input sub-region in the origin-destination input region, and the terminal creates an origin input interface in response to the operation, and jumps from the route planning interface to the origin input interface, whereby the target object performs various operations in the origin input interface. When the terminal detects an operation of the target object for the origin input interface, a route origin designated by the target object is obtained from the origin input interface in response to the operation.

In some embodiments, the operation of the target object for the origin input interface may be an input operation in the origin input interface, i.e. the target object may input a route origin in the origin input interface. In other embodiments, the operation of the target object for the origin input interface may also be a selection operation in the origin input interface. This selection operation may refer to a selection operation of a displayed historical search location for the origin input interface, or a location selection on a displayed map, i.e. a point selection operation. At this moment, the target object may designate a route origin by selecting the historical search location in the origin input interface or by the point selection operation.

In step S1012, the terminal jumps from the route planning interface to a destination input interface in response to the operation of the target object at the destination input sub-region, and acquires the route destination from the destination input interface in response to the operation of the target object at the destination input interface.

Similar to inputting the route origin, when inputting the route destination, the target object operates at the destination input sub-region in the origin-destination input region, and the terminal creates, in response to the operation and enters the destination input interface. When the terminal detects an operation of the target object for the destination input interface, a route destination designated by the target object is obtained from the destination input interface in response to the operation.

Similarly, the operation of the target object for the destination input interface may be either an input operation in the destination input interface or a selection operation in the destination input interface. This selection operation may refer to a selection operation of a displayed historical search location for the destination input interface, or a location selection on a displayed map, i.e. a point selection operation. At this moment, the target object may designate a route destination by selecting the historical search location in the destination input interface or by the point selection operation.

It is to be noted that when S101 includes all of the steps S1011-S1012, a final route origin and route destination will not be affected by determining whether to perform S1011 or S1012 first. Therefore, in some embodiments, the terminal may perform S1012 first and then perform S1011. In other embodiments, the terminal may perform S1011 and S1012 synchronously. This disclosure is not limited thereto herein.

In the embodiments of this disclosure, the terminal may jump to the origin input interface and the destination input interface correspondingly in response to the operation of the target object in the origin input sub-region and the destination input sub-region, respectively, and then acquire a route origin and a route destination according to the operations of the target object in the origin input interface and the destination input interface, so as to facilitate the subsequent start of route planning.

In some embodiments of this disclosure, the implementation process of S1011 in which the terminal acquires the route origin from the origin input interface in response to the operation of the target object at the origin input interface may include: the following S1011a or S1011b:

In step S1011a, the terminal receives a text input operation at a first text input region of the origin input interface, and takes a first input position indicated by a first input content inputted in the first text input region as the route origin in response to the text input operation.

When the terminal detects that the target object performs a text input operation in the first text input region of the origin input interface, it is clear that the target object currently designates the route origin by means of text input. At this moment, in response to the operation, the terminal acquires a first input content inputted by the target object from the first text input region, and uses the first input content as a route origin.

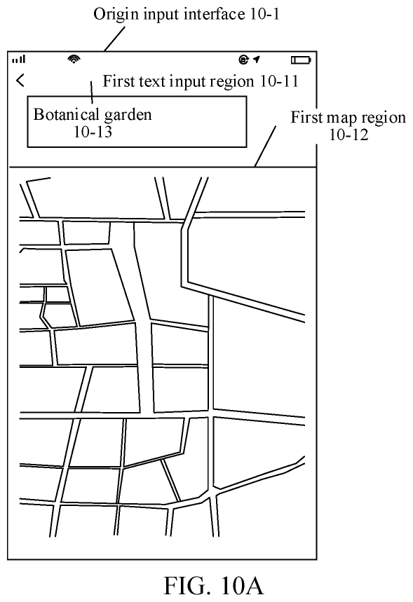

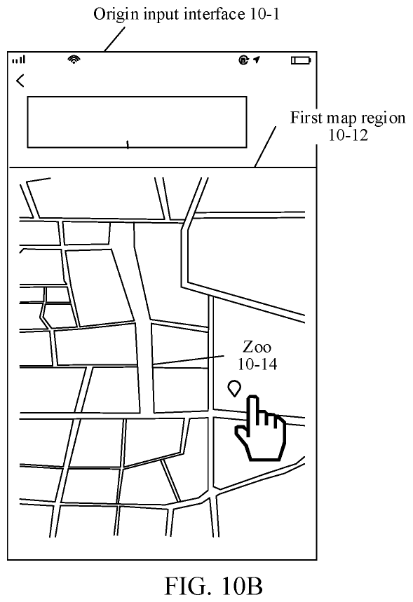

FIG. 10A is a first schematic diagram of acquiring a route origin according to embodiments of this disclosure. A first text input region 10-11 and a first map region 10-12 are arranged in an origin input interface 10-1. When the terminal detects that the target object inputs content in the first text region 10-11, a first input content inputted by the target object, i.e. a botanical garden 10-13, is taken as the route origin.

It is to be understood that when the target object starts a text input operation in the first text input region, the operation will trigger an input keyboard or writing pad to be popped up at the bottom of the origin input interface or below the first text input region, whereby the target object performs content input.

In step S1011b, the terminal receives a position selection operation in a first map region of the origin input interface, and takes a first geographic position selected by the position selection operation as the route origin in response to the position selection operation.

When the terminal detects that the target object performs a position selection operation in the first map region of the origin input interface, it is clear that the target object is currently designating the route origin by selecting a geographic position in a map. At this moment, in response to the operation, the terminal will take a first geographic position selected by the target object in the first map region as a route origin.

It is to be understood that the position selection operation may refer to an operation such as long-press or double-click of the target object in the first map region. This disclosure is not limited thereto herein.

FIG. 10B is a second schematic diagram of acquiring a route origin according to embodiments of this disclosure. When detecting that the target object long-presses a zoo 10-14 in a first map region 10-12 of an origin input interface 10-1, the terminal will take the zoo 10-14 as a route origin.

In the embodiments of this disclosure, the terminal may take a first input content inputted by the target object as a route origin in response to a text input operation of the target object, or a first geographic position selected by the target object as a route origin in response to a position selection operation of the target object. Thus, the target object may designate a route origin by text input, position selection, or the like.

In some embodiments of this disclosure, the implementation process of S1012 in which the terminal acquires the route destination from the destination input interface in response to the operation of the target object at the destination input interface may include: the following S1012a or S1012b:

In step S1012a, the terminal receives a text input operation at a second text input region of the destination input interface, and takes a position indicated by a second input content inputted in the second text input region as the route destination in response to the text input operation.

When the terminal detects that the target object performs a text input operation in the second text input region of the destination input interface, the terminal acquires, in response to the operation, a second input content inputted by the target object from the second text input region and takes the second input content as the route destination.

It is to be understood that when the target object starts a text input operation in the second text input region, the operation will trigger an input keyboard or writing pad to be popped up at the bottom of the destination input interface or below the second text input region, whereby the target object performs content input.

In step S1012b, the terminal receives a position selection operation at a second map region of the destination input interface, and takes a second geographic position selected by the position selection operation as the route destination in response to the position selection operation.

When the terminal detects that the target object performs a position selection operation in the second map region of the origin input interface, it is clear that the target object is currently designating the route destination by selecting a geographic position in a map. At this moment, in response to the operation, the terminal will take a second geographic position selected by the target object in the second map region as a route destination.

In the embodiments of this disclosure, the terminal may take a second input content inputted by the target object as a route destination in response to a text input operation of the target object, or a second geographic position selected by the target object as a route destination in response to a position selection operation of the target object. Thus, the target object may designate a route destination by text input, position selection, or the like.

In some embodiments of this disclosure, before the terminal receives an origin-destination determining operation for determining a route origin and a route destination, i.e. before S101, the method may further include: the following S107:

In step S107, the terminal displays a map application interface, and jumps from the map interface to the route planning interface in response to an operation based on a route generation identifier triggered by the map application interface.

Route planning is a function in map applications. In most map applications, route planning interfaces may be entered after a series of operations. In the embodiments of this disclosure, when the target object needs to perform route planning, a route generation identifier may be triggered on a map interface. In response to an operation of the target object for the route generation identifier, the terminal creates a route planning interface and jumps from the map interface to the created route planning interface so as to acquire a route origin and a route destination.

In some embodiments, the route generation identifier may be displayed in a third preset region of the map application interface after the target object has been triggered to enter the map application. At this moment, both the route origin and the route destination are required to be designated by the target object. In other embodiments, after the target object is triggered to enter the map application and searching for a certain location, the route generation identifier may be displayed in a fourth preset region of the map interface of the searched location. At this moment, when the target object triggers the route generation identifier, the terminal can take a current position of the target object as a route origin and the searched location of the target object as a route destination.

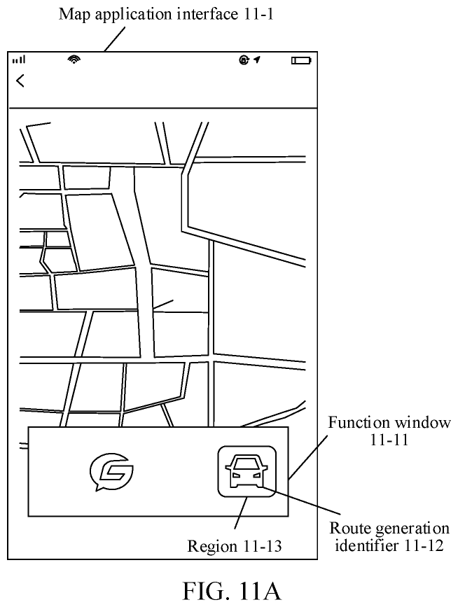

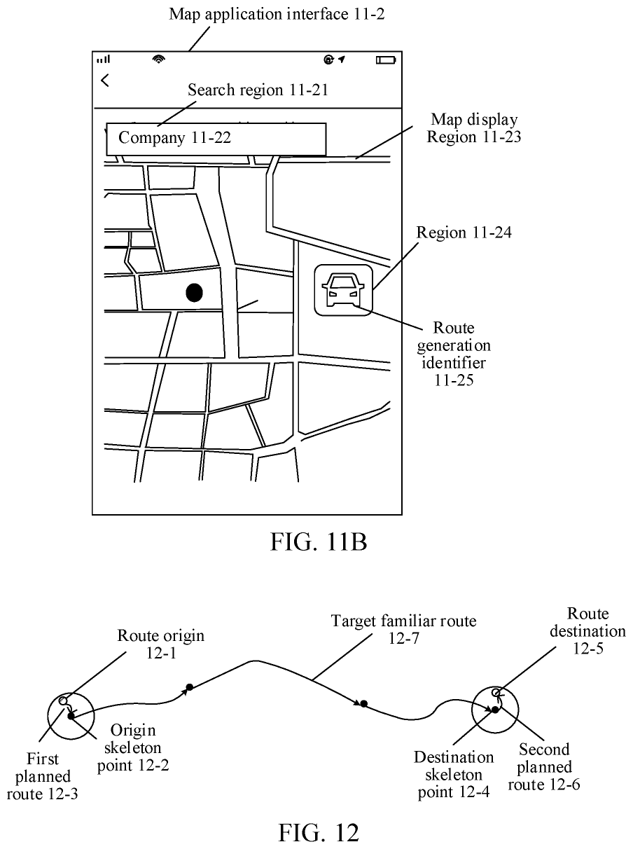

FIG. 11A is a first schematic diagram of a route generation identifier according to embodiments of this disclosure. Referring to FIG. 11A, a function window 11-11 is arranged in a map application interface 11-1. In the function window 11-11, a route generation identifier 11-12 is provided, and a region 11-13 where the identifier is located is a third preset region. FIG. 11B is a second schematic diagram of a route generation identifier according to embodiments of this disclosure. When the target object searches for a certain location, for example, a company 11-22, in a search region 11-21 of a map application interface 11-2, the terminal displays the position of the searched location of the target object in a map display region 11-23 of the map application interface 11-2, and displays a route generation identifier 11-25 in a region 11-24, so as to facilitate the user to trigger the entry of the route planning identifier.

In the embodiments of this disclosure, the terminal may enter a route planning interface in response to an operation of the target object for the route generation identifier in the map application interface, thereby reserving an interface for the target object to enter the route planning interface to perform a route planning function so as to facilitate use by the target object.

In some embodiments of this disclosure, the implementation process of S104 in which the server determines a planned route including the at least one target familiar route based on the respective skeleton points, the route origin and the route destination may include: the following S1041-S1044:

In step S1041, the server plans a route from the route origin to the respective origin skeleton points to obtain a first planned route.

In step S1042, the server plans a route from the respective destination skeleton points to the route destination to obtain a second planned route.

When determining a planned route, the server uses a route planning algorithm to plan a route between the route origin and each origin skeleton point, and takes the planned route as a first planned route corresponding to each origin skeleton point. Similarly, the server also uses a route calculation engine to plan a route between each destination skeleton point and the route destination so as to obtain a second planned route corresponding to each skeleton point.

It is to be understood that the route planning algorithm may be a breadth-first-search (BFS) algorithm, or may be a heuristic search algorithm, or may be a shortest path algorithm, such as a CH algorithm. This disclosure is not limited thereto herein.

FIG. 12 is a schematic diagram of generating a planned route according to embodiments of this disclosure. As shown in FIG. 12, when there is only one origin skeleton point and destination skeleton point, the server plans a first planned route 12-3 from a route origin 12-1 to an origin skeleton point 12-2 and a second planned route 12-6 from a destination skeleton point 12-4 to a route destination 12-5, and then takes a route obtained by connecting the first planned route 12-3, the second planned route 12-6 and a target familiar route 12-7 as a planned route.

In step S1043, the server restores the at least one target familiar route using the respective skeleton points.

The server calculates a route between points using the respective skeleton points, and completely restores at least one target familiar route. It is to be understood that, in some examples, since the server actually saves key road links with a unique topology structure when extracting skeleton points of the at least one target familiar route, it is possible to determine which road the target object has traveled when the origin out-degrees of the road links are not unique according to these road links with a unique topology structure, thereby obtaining at least one target familiar route.

It is to be noted that in this disclosure, the order of execution of S1041, S1042 and S1043 does not affect a final planned route. Therefore, in other embodiments, the server can perform S1041, S1042 and S1043 in an order other than the order given, e.g. perform S1043, S1042 and S1041 successively, etc.

In step S1044, the server determines the planned route including the at least one target familiar route based on the first planned route, the at least one target familiar route and the second planned route.

The server first splices the end of the first planned route of each origin skeleton point with the start of the target familiar route corresponding to each origin skeleton point, and then connects the end of the target familiar route with the start of the second planned route corresponding to each destination skeleton point, so as to obtain a planned route including at least one target familiar route. When route splicing is completed for all the target familiar routes, the planned route is obtained.

In the embodiments of this disclosure, since the route origin and the origin skeleton point of at least one target familiar route do not strictly match and the route destination and the destination skeleton point of the at least one target familiar route do not strictly match, the server will supplement the route from the route origin to the origin skeleton point, and supplement the route from the destination skeleton point to the route destination, so as to obtain a planned route including the at least one target familiar route, thereby subsequently returning the planned route to the terminal.

In some embodiments of this disclosure, the first planned route planned by the server includes: a plurality of first sub-routes, and the second planned route planned includes: a plurality of second sub-routes. At this moment, the implementation process of S1044 in which the server determines the planned route including the at least one target familiar route based on the first planned route, the at least one target familiar route and the second planned route may include: the following S1044a-S1044d:

In step S1044a, the server splices a current first sub-route in the plurality of first sub-routes, a current target familiar route corresponding to the first planned route in the at least one target familiar route, and a current second sub-route in the plurality of second sub-routes to obtain a spliced route corresponding to the current target familiar route.

The current first sub-route is any one of the plurality of first sub-routes, and the current second sub-route is any one of the plurality of second sub-routes.

Since each target familiar route has a corresponding origin skeleton point and destination skeleton point, a first planned route corresponding to each origin skeleton point will have a target familiar route corresponding thereto. Similarly, a second planned route corresponding to each destination skeleton point will also have a target familiar route corresponding thereto. The server randomly selects a first sub-route from the plurality of first sub-routes included in the first planned route as a current first sub-route, and randomly selects a second sub-route from the plurality of second sub-routes included in the second planned route as a current second sub-route. Next, the server performs splicing according to the order of the current first sub-route, the current target familiar route corresponding to the first planned route and the current second sub-route, and a route obtained by splicing (when the current second sub-route does not correspond to the current target familiar route, a route cannot be spliced, so that the current second sub-route included in the obtained spliced route will correspond to the current target familiar route certainly) is a spliced route corresponding to the current target familiar route.

In step S1044b, the server obtains, in a case that splicing of the plurality of first sub-routes and the plurality of second sub-routes with the current target familiar route is completed, a plurality of spliced routes corresponding to the current target familiar route.

The server splices each first sub-route and each second sub-route with a corresponding current target familiar route, so that the server obtains a plurality of spliced routes for the current target familiar route.

When the number of first sub-routes is n and the number of second sub-routes is m, the number of spliced routes may be n×m.

In step S1044c, the server selects candidate routes including the current target familiar route from the plurality of spliced routes based on matching degrees between the current target familiar route and the respective spliced routes respectively.

Since a display interface of the terminal is limited and the target object has limited energy to view the planned route, the server will generally select the best routes from a large number of routes as planned routes and return the planned routes to the terminal. Based on this, after obtaining a plurality of spliced routes, the server calculates matching degrees between the current target familiar route and each spliced route corresponding thereto one by one, and then selects a candidate route including the current target familiar route provided for the target object from these spliced routes according to the calculated matching degrees.

In step S1044d, the server determines, in a case that respective candidate routes are selected for the at least one target familiar route, the candidate routes as planned routes including the at least one target familiar route.

In the embodiments of this disclosure, the first planned route and the second planned route certainly have a corresponding relationship. When the first planned route includes a plurality of first sub-routes and the second planned route includes a plurality of first sub-routes, the server will splice any one of the first sub-routes, the target familiar route corresponding to the current first planned route and any one of the second sub-routes to obtain a plurality of spliced routes, select a more suitable candidate route for the current target familiar route according to the matching degrees between the respective spliced routes and the current target familiar route, and take the candidate route corresponding to each target familiar route as a planned route for subsequent return to the terminal.

In some embodiments of this disclosure, the implementation process of S1044c in which the server selects candidate routes from the plurality of spliced routes based on matching degrees between the current target familiar route and the respective spliced routes respectively may include: the following S201-S203:

In step S201, the server calculates matching degrees between the current target familiar route and the plurality of spliced routes respectively to obtain matching degrees corresponding to the respective spliced routes.

The server matches the current target familiar route and each spliced route in the plurality of spliced routes respectively to obtain a matching degree between the current target familiar route and each spliced route so as to obtain a matching degree corresponding to each spliced route. The spliced routes and the matching degrees have a one-to-one corresponding relationship.

It is to be understood that the server may calculate a matching degree between each spliced route and a familiar route through a similarity algorithm, or a fuzzy logic algorithm, etc.

In step S202, the server selects a preset number of matching degrees from the plurality of matching degrees in descending order as candidate matching degrees.

In step S203, the server takes spliced routes corresponding to the candidate matching degrees in the plurality of spliced routes as the candidate routes including the current target familiar route.

After obtaining a plurality of matching degrees, the server selects a preset number of matching degrees from the plurality of matching degrees in descending order, and takes the selected matching degrees as candidate matching degrees. Next, the server selects spliced routes corresponding to the candidate matching degrees from the plurality of spliced routes, and these selected spliced routes are candidate routes corresponding to the current target familiar route.

It is to be understood that the preset number may be set to 3 or 1 or other values according to actual situations. This disclosure is not limited thereto herein.

In the embodiments of this disclosure, the server calculates a matching degree between the current target familiar route and each spliced route corresponding thereto, then selects a certain number of candidate matching degrees from a plurality of matching degrees in descending order, and finally selects candidate routes corresponding to the candidate matching degrees from the plurality of spliced routes. Thus, the spliced route closer to the current target familiar route of the target object can be taken as a candidate route, so that a search space of the planned route can be greatly reduced, the route planning efficiency can be improved, the route recall capability can be enhanced, and the route diversity can be increased in consideration of the route origin, the route destination and the familiar route of the target object, thereby improving the degree of personalization of route planning.

It is to be understood that in some embodiments of this disclosure, the server may also train a corresponding personalized heuristic function for the target object by using a user portrait of the target object and the attributes of respective road links in the current target familiar route of the target object. Thus, the server may select, from the plurality of spliced routes, a spliced route that most matches the current target familiar route of the target object as a candidate route according to the personalized heuristic function.

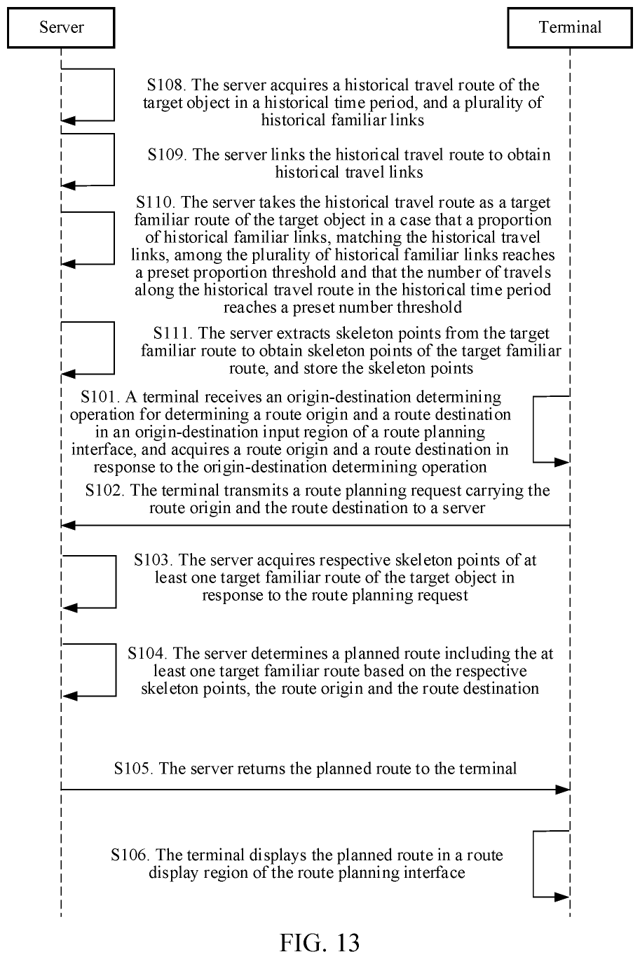

Based on FIG. 5, reference is made to FIG. 13. FIG. 13 is a second schematic flowchart of a route planning method according to embodiments of this disclosure. In some embodiments of this disclosure, before the terminal acquires a route origin and a route destination, and also before the server receives the route planning request, transmitted by the terminal, carrying the route origin and the route destination designated by the target object, i.e. before S101, the method may further include: the following S108-S111:

In step S108, the server acquires a historical travel route of the target object in a historical time period, and a plurality of historical familiar links.

In the embodiments of this disclosure, the server may mine a target familiar route of the target object from a historical travel route of the target object. At this moment, the server will first acquire a historical travel route of the target object in the historical time period from its own storage space or a database, and historical familiar links which have been determined as familiar links of the target object before the current familiar route mining. That is to say, the plurality of historical familiar links characterize that the historical familiar links have been determined as familiar links of the target object in the historical time period.

It is to be understood that the historical time period may be set according to actual situations. For example, half a year before the current time is taken as the historical time period, or one month before the current time is taken as the historical time period. This disclosure is not limited thereto herein.

In step S109, the server links the historical travel route to obtain historical travel links.

The server identifies different road links one by one from the historical travel route and takes these identified road links as historical travel links.

In step S110, the server takes the historical travel route as a target familiar route of the target object in a case that a proportion of historical familiar links, matching the historical travel links, among the plurality of historical familiar links reaches a preset proportion threshold and that the number of travels along the historical travel route in the historical time period reaches a preset number threshold.

The server matches the historical travel links one by one with each historical familiar link in the plurality of historical familiar links so as to obtain a matching degree between the historical travel link and each historical familiar link, selects historical familiar links matched with the historical travel links having a matching degree therebetween reaching a certain threshold, and calculates a proportion of the historical familiar links matched with the historical travel links among all the historical familiar links. Meanwhile, the server also counts the number of travels along the historical travel route in the historical time period. The server will confirm the historical travel route as a target familiar route of the target object in a case that the proportion of the historical familiar links matched with the historical travel links reaches a preset proportion threshold and that the number of travels along the historical travel route in the historical time period reaches a preset number threshold.

It is to be understood that the preset proportion threshold may be set according to actual situations, for example, as 90%, or as 50%, etc. This disclosure is not limited thereto herein. Similarly, the preset number threshold may also be set according to actual situations, for example, as 20, or as 5, etc. This disclosure is not limited thereto herein.

In step S111, the server extracts skeleton points from the target familiar route to obtain skeleton points of the target familiar route, and store the skeleton points.

After obtaining the target familiar route of the target object, the server will perform skeleton point extraction on the obtained target familiar route, i.e. extract road links which can uniquely represent a topological structure of the target familiar route in the target familiar route so as to obtain and store skeleton points of the target familiar route.

In the embodiments of this disclosure, the server can acquire a historical travel route of the target object and a plurality of historical familiar links, match the historical travel links obtained by linking the historical travel route with the plurality of historical familiar links, also count the number of travels along the historical travel route in the historical time period, and determine whether the historical travel route is a familiar route of the target object according to a matching proportion and the number of travels. When the server determines that the historical travel route is the target familiar route, skeleton points are extracted from the target familiar route. Thus, the server may store only the skeleton points of the target familiar route, thereby reducing the amount of data required to be stored and also reducing the storage pressure.

In some embodiments of this disclosure, the implementation process of S111 in which the server extracts skeleton points from the target familiar route to obtain skeleton points of the target familiar route may include: the following S1111-S1114:

In step S1111, the server links the target familiar route to obtain a plurality of road links, and determines origin out-degrees respectively corresponding to the plurality of road links.

The server identifies road links included in the target familiar route and segments the road links to obtain a plurality of road links. Next, the server counts the number of paths reaching each road link, and this counted number is the origin out-degree. That is, the origin out-degree characterizes the number of paths reaching each road link.

In step S1112, the server extracts origin out-degrees respectively corresponding to the plurality of road links, and extracts a plurality of dissimilar road links from the plurality of road links.

In some examples, the server determines a subset of the road links that can be used to restore the plurality of road links. For example, the server identifies, for each of road links other than an origin road link and a destination road link, an origin out-degree respectively, ignores the road link with the origin out-degree of 1, and extracts topologically unique road links, thereby obtaining a plurality of dissimilar road links. That is to say, the plurality of dissimilar road links are topologically unique road links in the plurality of road links.

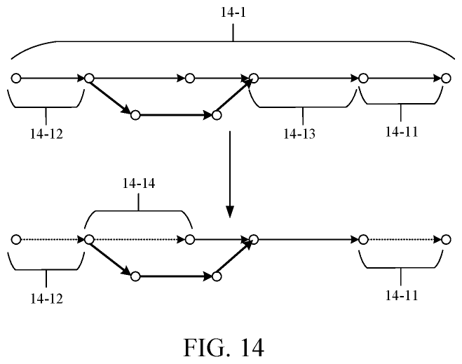

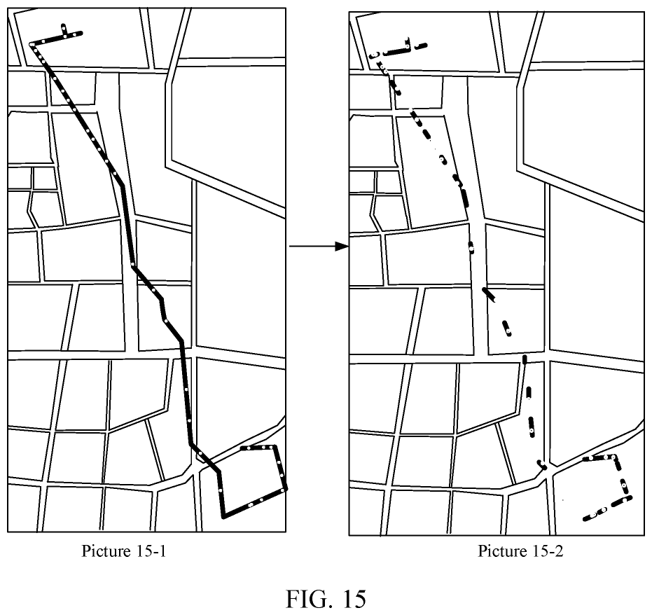

FIG. 14 is a schematic diagram of extracting dissimilar road links according to embodiments of this disclosure. In FIG. 14, the target familiar route is linked, and a plurality of road links 14-1 are obtained, and two paths may reach a destination road link 14-11. The server respectively counts origin out-degrees of road links other than the destination road link 14-11 and an origin road link 14-12, and finds that the origin out-degree of a road link 14-13 is 2. Thus, the server searches, starting from the road link to the origin road link, a road link along which the target object actually travels, i.e. a topologically unique road link 14-14, thereby taking the road link as a dissimilar road link.

It is to be noted that the amount of data for the target familiar route can be reduced by extracting dissimilar road links. FIG. 15 is a schematic diagram of reducing the amount of data through extraction of dissimilar road links according to embodiments of this disclosure. As shown in FIG. 15, a picture 15-1 shows that 184 road links are obtained after the target familiar route is linked. Each road link is labeled with two white dots. The extracted dissimilar road links are shown in a picture 15-2. At this moment, the number of road links to be stored in the target familiar route has been reduced to 45 road links (short black lines), thereby greatly reducing the amount of data.

In step S1113, the server thins the plurality of dissimilar road links to obtain candidate road links.

Through the extraction of dissimilar road links, the server can reduce redundant data for the target familiar route, but in order to reduce the amount of data, the server will continue to thin the plurality of dissimilar road links to obtain candidate road links.

In step S1114, the server takes the origin road link, the candidate road links and the destination road link as the skeleton points of the target familiar route.

The server directly takes an origin road link as an origin skeleton point, a destination road link as a destination skeleton point, a candidate road link as an intermediate skeleton point, and the origin skeleton point, the destination skeleton point and the intermediate skeleton point as skeleton points of the target familiar route, so that the amount of data of the target familiar route can be compressed.

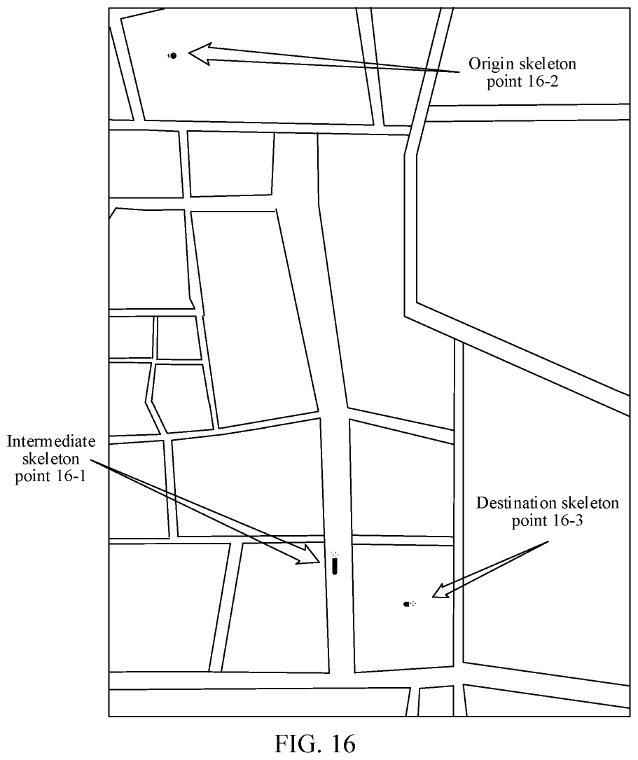

FIG. 16 is a schematic diagram of skeleton points of a target familiar route according to embodiments of this disclosure. The server obtains candidate road links as intermediate skeleton points 16-1 by thinning 45 dissimilar road links shown in the picture 15-2 in FIG. 15, and then obtains respective skeleton points of the target familiar route by taking an origin road link as an origin skeleton point 16-2 and a destination road link as a destination skeleton point 16-3. It can be seen from FIG. 16 that the skeleton point of the target familiar route has only three road links, and the amount of data is very small.

In some embodiments of this disclosure, the implementation process of S1113 in which the server thins the plurality of dissimilar road links to obtain candidate road links may include: the following S1113a:

In step S1113a, the server takes, in a case that a current dissimilar road link is not on a target path of a dissimilar road link following the current dissimilar road link, the current dissimilar road link as the candidate road link so as to realize thinning of the plurality of dissimilar road links.

The current dissimilar road link is any one of the plurality of dissimilar road links.

The server randomly selects a dissimilar road link from the plurality of dissimilar road links as a current dissimilar road link, acquires the previous dissimilar road link of the current dissimilar road link, and determines whether the current dissimilar road link is on a target path of the next dissimilar road link by calculating the current dissimilar road link and the previous dissimilar road link in artificial intelligence. The server takes, in a case that the current dissimilar road link is not on a target path of the next dissimilar road link, the current dissimilar road link as the candidate road link. Thus, the server can obtain the candidate road links.

It is to be noted that in some embodiments of this disclosure, the server immediately starts a next round of target familiar route mining for the target object after returning the planned route to the terminal, so that the target familiar route is always the latest.

In the embodiments of this disclosure, the server first obtains a plurality of road links for a target familiar route, extract a plurality of dissimilar road links from road links other than an origin road link and a destination road link according to an origin out-degree of each road link, then extract candidate skeleton points from the plurality of dissimilar road links by calculating routes for the plurality of dissimilar road links, and finally obtain skeleton points of the target familiar route according to the candidate road links, the origin road link and the destination road link, so as to facilitate subsequent restoration of the target familiar route using the skeleton points.

The following describes an exemplary application of this embodiment of this disclosure in an actual application scenario.

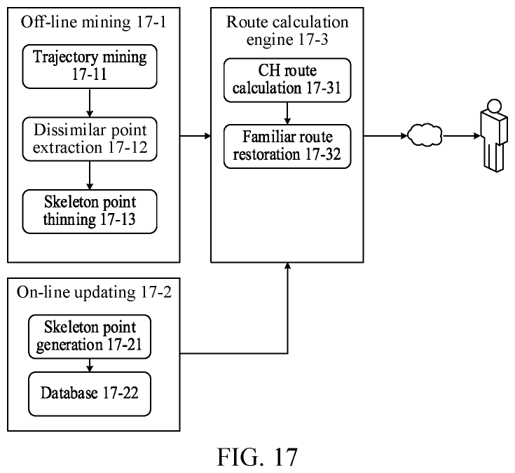

The embodiments of this disclosure are realized in a scenario where a cloud (server) generates a planned route for a user (target object). FIG. 17 is an overall architectural diagram of generating a planned route according to embodiments of this disclosure.

Referring to FIG. 17, the generation process of the planned route may include off-line mining 17-1, on-line updating 17-2 and a route calculation engine 17-3. The off-line mining 17-1 is responsible for identifying a familiar path (target familiar route) of a user, i.e. mining a route with a higher driving frequency of the user, i.e. performing trajectory mining 17-11, and generating a data file for use by the on-line route calculation engine 17-3 after dissimilar point extraction 17-12 (dissimilar road link) and skeleton point thinning 17-13. The on-line updating 17-2 is responsible for skeleton point generation 17-21 and storing skeleton points in a database 17-22 (storing the respective skeleton points). The route calculation engine 17-3 is responsible for determining whether a current request (route planning request, including a route origin and a route destination) of a user hits a familiar path through CH route calculation 17-31, and if so, performing familiar route restoration 17-32 and generating a route (planned route including at least one target familiar route) returned to the user.

Here, the familiar path means that user trajectory route fragments (historical travel links) are matched with at least 90% (preset proportion threshold) of familiar route fragments (historical familiar links), and a user travels for N times (preset number threshold) or more within half a year (historical time period).

The dissimilar point extraction 17-12 is to obtain a plurality of dissimilar fragments (a plurality of dissimilar road links) by ignoring fragments with a start node out-degree (an origin out-degree) of 1 and saving topologically unique fragments (a plurality of dissimilar road links are topologically unique road links in the plurality of road links) other than an origin fragment (origin road link) and a destination fragment (destination road link).

In the skeleton point thinning 17-13, the cloud uses a CH route calculation engine and a basic static weight to inspect a dissimilar fragment string obtained from the dissimilar point extraction 17-12, and performs One2Many route calculation from a preceding fragment of a current dissimilar fragment (current dissimilar road link) to a subsequent dissimilar fragment (next dissimilar road link). If it is determined that the current dissimilar fragment is on a target path of the subsequent dissimilar fragment, the current dissimilar fragment may be ignored, i.e. when the current dissimilar fragment is not on the target path of the subsequent dissimilar fragment, the current dissimilar fragment is taken as a skeleton point.

The route calculation engine 17-3 determines a current navigation origin and destination of a user (a route origin and a route destination), and when a familiar path origin and destination (an origin skeleton point and a destination skeleton point) are within a certain range (preset range), it is considered that the navigation origin and destination hit the familiar route. Next, the route calculation engine performs route calculation between the current navigation origin (route origin) and the familiar path origin (origin skeleton point) and between the familiar path destination (destination skeleton point) and the current navigation destination (route destination) through the CH route calculation 17-31, plans an optimal solution (i.e. obtaining a first planned route and a second planned route), obtains a familiar path through the route restoration 17-32, obtains an on-line planned route (planned route) based on the planned optimal solution and familiar path, sorts matching degrees between the on-line planned route and the familiar route according to the on-line planned route and an off-line mined route, and returns a sorting result to a mobile phone (terminal) of the user.

By means of the above manner, when planning a route for a user, a familiar route of the user has a certain generalization ability, and the preferred route of the user can be restored to the maximum extent, so that route planning is more understandable to the user, i.e. route planning is more personalized and intelligent. Furthermore, the amount of data required to be stored in paths familiar to users can be greatly compressed by means of skeleton point extraction, thereby reducing the storage memory.

An exemplary structure of the route planning apparatus 455 according to the embodiments of this disclosure being implemented as a software module is continuously described below. In some embodiments, as shown in FIG. 3, the software module in the route planning apparatus 455 stored in the first memory 450 may include an origin-destination acquiring module 4551, a first transmitting module 4552 and a first receiving module 4553.

The origin-destination acquiring module 4551 is configured to receive an origin-destination determining operation for determining a route origin and a route destination in an origin-destination input region of a route planning interface, and acquire a route origin and a route destination in response to the origin-destination determining operation.

The first transmitting module 4552 is configured to transmit a route planning request carrying the route origin and the route destination to a server.

The first receiving module 4553 is configured to receive a planned route returned by the server for the route planning request and including at least one target familiar route of a target object. The planned route is determined according to respective skeleton points of the target familiar route, the route origin and the route destination. A distance between the route origin and an origin skeleton point of the target familiar route and a distance between the route destination and a destination skeleton point of the target familiar route are within a preset range.

In some embodiments, the apparatus further includes: an information displaying module 4554, configured to display the planned route in a route display region of the route planning interface.

In some embodiments, the information displaying module 4554 is further configured to extract the target familiar route from the at least one planned route; and differentially display, in a route display region of the route planning interface, the target familiar route, and routes other than the target familiar route in the at least one planned route.

In some embodiments, the information displaying module 4554 is further configured to blink the target familiar route or highlight the target familiar route.

In some embodiments of this disclosure, the origin-destination input region includes: an origin input sub-region and a destination input sub-region. The origin-destination determining operation includes: an operation at the origin input sub-region and an operation at the destination input sub-region.

The origin-destination acquiring module 4551 is further configured to jump from the route planning interface to an origin input interface in response to the operation of the target object at the origin input sub-region, and acquire the route origin from the origin input interface in response to the operation of the target object at the origin input interface; and jump from the route planning interface to a destination input interface in response to the operation at the destination input sub-region, and acquire the route destination from the destination input interface in response to the operation of the target object at the destination input interface.

In some embodiments of this disclosure, the origin-destination acquiring module 4551 is further configured to receive a text input operation at a first text input region of the origin input interface, and determine a position indicated by a first input content inputted in the first text input region as the route origin in response to the text input operation; or, receive a position selection operation at a first map region of the origin input interface, and determine a first geographic position selected by the position selection operation as the route origin in response to the position selection operation.

In some embodiments of this disclosure, the origin-destination acquiring module 4551 is further configured to receive a text input operation at a second text input region of the destination input interface, and determine a position indicated by a second input content inputted in the second text input region as the route destination in response to the text input operation; or, receive a position selection operation at a second map region of the destination input interface, and determine a second geographic position selected by the position selection operation as the route destination in response to the position selection operation.

In some embodiments of this disclosure, the information displaying module 4554 is further configured to display a map application interface, and jump from the map interface to the route planning interface in response to an operation based on a route generation identifier triggered by the map application interface.

An exemplary structure of the route planning apparatus 255 according to the embodiments of this disclosure being implemented as a software module is continuously described below. In some embodiments, as shown in FIG. 4, the software module in the route planning apparatus 255 stored in the second memory 250 may include a second receiving module 2551, a skeleton point acquiring module 2552, a route determining module 2553, and a second transmitting module 2554.

The second receiving module 2551 is configured to receive a route planning request transmitted by a terminal and corresponding to a target object, the route planning request carrying a route origin and a route destination.

The skeleton point acquiring module 2552 is configured to acquire respective skeleton points of at least one target familiar route of the target object in response to the route planning request, the target familiar route being determined based on a historical travel route of the target object.

The route determining module 2553 is configured to determine a planned route including the at least one target familiar route based on the respective skeleton points, the route origin and the route destination, a distance between the route origin and at least one origin skeleton point in the respective skeleton points being within a preset range, and a distance between the route destination and at least one destination skeleton point in the respective skeleton points being within a preset range.

The second transmitting module 2554 is configured to return the planned route to the terminal.

In some embodiments of this disclosure, the route determining module 2553 is further configured to plan a route from the route origin to each origin skeleton point in the at least one origin skeleton point to obtain a first planned route; plan a route from each destination skeleton point in the at least one destination skeleton point to the route destination to obtain a second planned route; restore the at least one target familiar route using the respective skeleton points; and determine the planned route including the at least one target familiar route based on the first planned route, the at least one target familiar route and the second planned route.

In some embodiments of this disclosure, the first planned route includes: a plurality of first sub-routes, and the second planned route includes: a plurality of second sub-routes. The route determining module 2553 is further configured to splice a current first sub-route in the plurality of first sub-routes, a current target familiar route corresponding to the first planned route in the at least one target familiar route, and a current second sub-route in the plurality of second sub-routes to obtain a spliced route corresponding to the current target familiar route, the current first sub-route being any one of the plurality of first sub-routes, and the current second sub-route being any one of the plurality of second sub-routes; obtain, in a case that splicing of the plurality of first sub-routes and the plurality of second sub-routes with the current target familiar route is completed, a plurality of spliced routes corresponding to the current target familiar route; select candidate routes including the current target familiar route from the plurality of spliced routes based on matching degrees between the current target familiar route and the plurality of spliced routes respectively; and use, in a case that respective candidate routes are selected for the at least one target familiar route, the candidate routes as planned routes including the at least one target familiar route.

In some embodiments of this disclosure, the route determining module 2553 is further configured to calculate matching degrees between the current target familiar route and the plurality of spliced routes respectively to obtain a plurality of matching degrees corresponding to the plurality of spliced routes; select a preset number of candidate matching degrees from the plurality of matching degrees in descending order; and take spliced routes corresponding to the candidate matching degrees in the plurality of spliced routes as the candidate routes including the current target familiar route.

In some embodiments of this disclosure, the route planning apparatus 255 further includes: a skeleton point generating module 2555. The skeleton point generating module 2555 is configured to acquire a historical travel route of the target object in a historical time period, and a plurality of historical familiar links, the plurality of historical familiar links characterizing that the historical familiar links have been determined as familiar links of the target object in the historical time period; link the historical travel route to obtain historical travel links; take the historical travel route as a target familiar route of the target object in a case that a proportion of historical familiar links, matching the historical travel links, among the plurality of historical familiar links reaches a preset proportion threshold and that the number of travels along the historical travel route in the historical time period reaches a preset number threshold; and extract skeleton points from the target familiar route to obtain skeleton points of the target familiar route, and store the skeleton points.

In some embodiments of this disclosure, the skeleton point generation module 2555 is further configured to link the target familiar route to obtain a plurality of road links, and determine origin out-degrees respectively corresponding to the plurality of road links, the origin out-degree characterizing the number of paths reaching each road link; extract a plurality of dissimilar road links from road links, other than an origin road link and a destination road link, among the plurality of road links according to the origin out-degrees respectively corresponding to the plurality of road links, the plurality of dissimilar road links being topologically unique road links in the plurality of road links; thin the plurality of dissimilar road links to obtain candidate road links; and take the origin road link, the candidate road links and the destination road link as the skeleton points of the target familiar route.

In some embodiments of this disclosure, the skeleton point generation module 2555 is further configured to take, in a case that a current dissimilar road link is not on a target path of a dissimilar road link following the current dissimilar road link, the current dissimilar road link as the candidate road link so as to realize thinning of the plurality of dissimilar road links, the current dissimilar road link being any one of the plurality of dissimilar road links.

One or more modules, submodules, and/or units in the present disclosure can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

According to an aspect of the embodiments of this disclosure, a computer program product or a computer program is provided, the computer program product or the computer program including computer instructions, the computer instructions being stored in a computer-readable storage medium. A processor of a computer device reads the computer instructions from the computer-readable storage medium, and executes the computer instructions, to cause the computer device to perform the foregoing route planning method in the embodiment of this disclosure.

An embodiment of this disclosure provides a computer-readable storage medium (e.g., a non-transitory computer-readable storage medium) storing an executable route planning instruction. When the executable route planning instruction is executed by a first processor, the first processor is caused to perform the route planning method provided by the terminal side in the embodiments of this disclosure, or when the executable route planning instruction is executed by a second processor, the second processor is caused to perform the route planning method provided by the server side in the embodiments of this disclosure.

In some embodiments, the computer-readable storage medium may be a memory such as an FRAM, a ROM, a PROM, an EPROM, an EEPROM, a flash memory, a magnetic surface memory, an optical disk, or a CD-ROM; or may be any device including one of or any combination of the foregoing memories.

In some embodiments, the executable route planning instructions may be written in any form of programming language (including a compiled or interpreted language, or a declarative or procedural language) by using the form of a program, software, a software module, a script or code, and may be deployed in any form, including being deployed as an independent program or being deployed as a module, a component, a subroutine, or another unit suitable for use in a computing environment.

In an example, the executable route planning instructions may, but do not necessarily, correspond to a file in a file system, and may be stored in a part of a file that saves another program or other data, for example, be stored in one or more scripts in a hypertext markup language (HTML) file, stored in a file that is specially used for a program in discussion, or stored in the plurality of collaborative files (for example, be stored in files of one or modules, subprograms, or code parts).

In an example, the executable route planning instructions may be deployed to be executed on a computing device, or deployed to be executed on a plurality of computing devices at the same location, or deployed to be executed on a plurality of computing devices that are distributed in a plurality of locations and interconnected by using a communication network.

The foregoing descriptions are merely exemplary embodiments of this disclosure and are not intended to limit the scope of this disclosure. Any modification, equivalent replacement, or improvement made without departing from the spirit and range of this disclosure shall fall within the scope of this disclosure.

What is claimed is:

1. A method for route planning, comprising:
detecting one or more operations indicative of inputting a route origin and a route destination in an origin-destination input region of a route planning interface;
acquiring the route origin and the route destination in response to the one or more operations;
transmitting, to a route planning server, a route planning request that includes the route origin and the route destination, the route planning request being associated with a travel entity with historical travel information available at the route planning server; and
receiving at least one planned route in response to the route planning request, the at least one planned route including a first planned route with a familiar route portion determined based on a historical travel route of the travel entity, the first planned route including the route origin, the familiar route portion with an origin skeleton point and a destination skeleton point, and the route destination, a first distance between the route origin and the origin skeleton point of the familiar route portion, and a second distance between the route destination and the destination skeleton point of the familiar route portion being within a preset range.

2. The method according to claim 1, further comprising:
displaying the at least one planned route with the familiar route portion being displayed differentially from other portions in the at least one planned route.

3. The method according to claim 2, further comprising:
blinking or highlighting the display of the familiar route portion.

4. The method according to claim 1, wherein
the origin-destination input region includes an origin input sub-region and a destination input sub-region, the acquiring the route origin and the route destination in response to the one or more operations comprises:
switching from the route planning interface to an origin input interface in response to a first operation at the origin input sub-region;
acquiring the route origin from the origin input interface in response to a second operation at the origin input interface;
switching from the route planning interface to a destination input interface in response to a third operation at the destination input sub-region; and
acquiring the route destination from the destination input interface in response to a fourth operation at the destination input interface.

5. The method according to claim 4, wherein the acquiring the route origin from the origin input interface in response to the second operation at the origin input interface comprises:
receiving first input content in a first text input region of the origin input interface, and determining a first geographic position corresponding to the first input content as the route origin; or
receiving first information of a first position selected in a first map region of the origin input interface, and determining the first geographic position corresponding to the first position as the route origin.

6. The method according to claim 4, wherein the acquiring the route destination from the destination input interface in response to the fourth operation at the destination input interface comprises:
receiving second input content in a second text input region of the destination input interface, and determining a second geographic position corresponding to the second input content as the route destination; or
receiving second information of a second position selected in a second map region of the destination input interface, and determining a second geographic position corresponding to the second position as the route destination.

7. The method according to claim 1, further comprising:
displaying a map application interface; and
switching from the map application interface to the route planning interface in response to an operation on a route generation identifier in the map application interface.

8. A method for route planning, comprising:
receiving a route planning request from a terminal device, the route planning request being associated with a travel entity, the route planning request carrying a route origin and a route destination;
acquiring at least one familiar route of the travel entity, the at least one familiar route being determined based on historical travel routes of the travel entity, the at least one familiar route being respectively formed by skeleton points including an origin skeleton point and a destination skeleton point;
determining, a planned route including at least a first familiar route portion corresponding to a first familiar route in the at least one familiar route of the travel entity, based on the at least one familiar route, the route origin, and the route destination, the first familiar route including first skeleton points including a first origin skeleton point and a first destination skeleton point, a first distance between the route origin and the first origin skeleton point being within a first preset range, and a second distance between the route destination and the first destination skeleton point being within a second preset range; and
sending the planned route to the terminal device.

9. The method according to claim 8, wherein the determining the planned route comprises:
planning a first route from the route origin to the first origin skeleton point to obtain a first planned route portion;
planning a second route from the first destination skeleton point to the route destination to obtain a second planned route portion;
restoring the first familiar route portion using the first skeleton points of the first familiar route; and
determining the planned route including the first planned route portion, the first familiar route portion, and the second planned route portion.

10. The method according to claim 9, wherein
the first route includes a plurality of first candidate sub-routes,
the second route includes a plurality of second candidate sub-routes, and the determining the planned route comprises:
forming a plurality of spliced routes corresponding to the first familiar route, a spliced route in the plurality of spliced routes including a first candidate sub-route in the plurality of first candidate sub-routes, the first familiar route portion, and a second candidate sub-route in the plurality of second candidate sub-routes; and
selecting the planned route from the plurality of spliced routes based on respective matching degrees between the first familiar route and the plurality of spliced routes.

11. The method according to claim 10, wherein the selecting the planned route comprises:
determining the respective matching degrees between the first familiar route and the plurality of spliced routes; and
selecting a preset number of spliced routes from the plurality of spliced routes with higher matching degrees as candidates for the planned route.

12. The method according to claim 8, further comprising:
acquiring a first historical travel route of the travel entity in a historical time period, and a plurality of historical familiar links of the travel entity in the historical time period;
determining historical travel links from the first historical travel route; and
determining the first historical travel route to be a new familiar route of the travel entity when a proportion of a subset of the historical familiar links that have matching links in the plurality of historical familiar links reaches a preset proportion threshold and a number of travels along the first historical travel route in the historical time period reaches a preset number threshold.

13. The method according to claim 12, further comprising:
determining a plurality of road links from the new familiar route;
determining origin out-degrees respectively for the plurality of road links, an origin out-degree for a road link characterizing a number of paths reaching the road link;
extracting one or more dissimilar road links from the plurality of road links excluding an origin road link and a destination road link according to the origin out-degrees respectively for the plurality of road links, the plurality of road links being restorable based on the one or more dissimilar road links;
reducing redundancy in the plurality of road links based on the one or more dissimilar road links to obtain candidate road links; and
using the origin road link, the candidate road links, and the destination road link as the skeleton points of the new familiar route.

14. The method according to claim 13, wherein the reducing redundancy comprises:
using, in response to a current dissimilar road link not being on a target path of a next dissimilar road link following the current dissimilar road link, the current dissimilar road link as a candidate road link, the current dissimilar road link being one of the one or more dissimilar road links.

15. An apparatus comprising processing circuitry configured to:
detect one or more operations indicative of inputting a route origin and a route destination in an origin-destination input region of a route planning interface;
acquire the route origin and the route destination in response to the one or more operations;
transmit, to a route planning server, a route planning request that includes the route origin and the route destination, the route planning request being associated with a travel entity with historical travel information available at the route planning server; and
receive at least one planned route in response to the route planning request, the at least one planned route comprising a first planned route with a familiar route portion determined based on a historical travel route of the travel entity, the first planned route comprising the route origin, the familiar route portion with an origin skeleton point and a destination skeleton point, and the route destination, a first distance between the route origin and the origin skeleton point of the familiar route portion, and a second distance between the route destination and the destination skeleton point of the familiar route portion being within a preset range.

16. The apparatus according to claim 15, wherein the processing circuitry is configured to display, via a display screen, the at least one planned route with the familiar route portion being displayed differentially from other portions in the at least one planned route.

17. The apparatus according to claim 16, wherein the processing circuitry is configured to Blink or highlight display of the familiar route portion.

18. The apparatus according to claim 15, wherein the origin-destination input region includes an origin input sub-region and a destination input sub-region, and the processing circuitry is configured to:
switch from the route planning interface to an origin input interface in response to a first operation at the origin input sub-region;
acquire the route origin from the origin input interface in response to a second operation at the origin input interface;
switch from the route planning interface to a destination input interface in response to a third operation at the destination input sub-region; and
acquire the route destination from the destination input interface in response to a fourth operation at the destination input interface.

19. The apparatus according to claim 18, wherein the processing circuitry is configured to:
receive first input content in a first text input region of the origin input interface, and determine a first geographic position corresponding to the first input content as the route origin; or
receive first information of a first position selected in a first map region of the origin input interface, and determine the first geographic position corresponding to the first position as the route origin.

20. The apparatus according to claim 18, wherein the processing circuitry is configured to:
receive second input content in a second text input region of the destination input interface, and determine a second geographic position corresponding to the second input content as the route destination; or
receive second information of a second position selected in a second map region of the destination input interface, and determine a second geographic position corresponding to the second position as the route destination.
